(19) United States
(12) Patent Application Publication
(10) Pub. No.: US 2019/0232396 A1
(43) Pub. Date: Aug. 1, 2019

(54) Milling cutter

(71) Applicant: DATRON AG, Muhltal (DE)

(72) Inventor: Benjamin Bock, Brensbach/Wersau (DE)

(21) Appl. No.: 16/258,549

(22) Filed: Jan. 26, 2019

(30) Foreign Application Priority Data
Jan. 26, 2018 (DE) 10 2018 101 854

(51) Int. Cl. B23C 5/16; B23C 5/00

(52) U.S. Cl. CPC B23C 5/165; B23C 5/006; B23C 2250/08; B23C 2210/486; B23C 2250/04; B23C 2210/201

(57) ABSTRACT

A milling tool has a shank and a milling portion arranged along a longitudinal axis of the milling tool. The milling portion has at least one peripheral blade and a flute that adjoins a cutting edge of the peripheral blade. A radial spacing between the cutting edge and the longitudinal axis is selected on the basis of a specified compensation rotational speed such that a shell surface formed by the rotating cutting edge is circular cylindrical in the case of a rotation of the milling tool at the compensation rotational speed. The radial spacing of the cutting edge increases continuously or decreases continuously as the distance from the shank increases.

### TECHNICAL FIELD

The disclosure relates to a milling tool comprising a shank and a milling portion which are arranged along a longitudinal axis of the milling tool. The milling portion comprises at least one peripheral blade that extends over the milling portion, in the direction of the longitudinal axis, at least in portions with a flute that adjoins a cutting edge of the peripheral blade.

### BACKGROUND

Milling tools that can be used for shaping machining of solid materials are known in numerous different embodiments and variants. The milling tools generally comprise a blade or a plurality of blades which are either formed integrally on the milling tool or can be produced separately and subsequently connected to a main body of the milling tool. In the event of a rotational movement of the milling tool about an axis of rotation which generally coincides with the longitudinal axis of the milling tool, the blades come into engagement with a workpiece to be machined, with the result that material can be cut off the workpiece and removed.

Milling tools are known that comprise one or comprise a plurality of end blades which each extend on an end face, transversely to an axis of rotation of the milling tool. Milling tools comprising one or comprising a plurality of end blades are suitable in particular for plunging in the longitudinal direction into a workpiece to be machined and creating a bore that is specified by a diameter of the milling tool.

Milling tools comprising a peripheral blade that extends along the longitudinal axis can be displaced transversely to the longitudinal axis about which the milling tool is generally rotated during use, and in the process can remove material, in the form of chips, from the workpiece to be machined, during each rotation of the peripheral blade. In this case, the chips are removed from the workpiece to be machined, along the longitudinal axis, by means of a flute that adjoins a cutting edge of the peripheral blade. The further the peripheral blade extends along the milling portion, from an end face of the milling tool towards the shank, the deeper the milling tool can plunge into the workpiece to be machined, and the larger the workpiece portions that can be manufactured in one work step. Many milling tools comprise both an end blade and at least one peripheral blade.

Milling tools comprising two or more peripheral blades, which blades are mutually spaced in the peripheral direction of the milling tool, generally require an allocated flute for each peripheral blade, the course of which channel along the longitudinal axis follows the course of the peripheral blade. The largest possible usable volume of the flutes, desired in view of removing the material that has been cut off, is limited in practice by requirements regarding the strength of the milling tool. Each flute is a recess extending along the longitudinal axis of the milling tool, which recess reduces the strength of the milling tool and limits the parameters relevant for a milling process, for example the rotational speed and the displacement speed of the milling tool.

Milling tools are also known that comprise just one peripheral blade extending along the longitudinal axis, and are therefore referred to as incision milling tools. Since just one peripheral blade having one adjoining flute is arranged in the shank, incision milling tools make it possible for a comparatively large recess to be formed for the flute, without thereby imposing excessive restrictions with regard to the possible mechanical loading of the milling tool during a milling process.

It is considered advantageous, for various applications, for the milling tool to rotate at a high rotational speed of for example 20,000 or more rotations per minute. In the meantime, significantly higher rotational speeds of 40,000 or 60,000 rotations per minute, and in some cases even higher, have already been achieved. It has been found that, in the case of high rotational speeds of this kind, very high material removal rates and surface qualities can be achieved in the workpiece to be machined, and at the same time the wear on the milling tool associated therewith is extremely low.

However, in the event of high rotational speeds of the rotating milling tool, even very small imbalances of the milling tool have a significant negative effect on the milling process. In this case, an uneven distribution of mass in an imbalanced milling tool causes a significantly increased noise level during a milling process, and an excessive increase in wear, specifically both on the milling tool itself and on the tool holder by means of which the shank of the milling tool is mounted in the milling machine.

In order to reduce these disadvantageous effects, it is known from practice that in particular milling tools that are designed for milling processes having high rates of revolution are balanced, as far as possible, in order to reduce the disadvantageous effects of imbalance at high rates of revolution. In this case, static or dynamic balancing methods are known, by means of which either the distribution of mass of the milling tool is considered as a whole and optimized over the entire extension thereof along the longitudinal axis, or by means of which a distribution of mass that is optimized and as uniform as possible is specified, along the longitudinal axis, for each individual portion. It has been found that an imbalance of the milling tool that results from the desired arrangement of the one or more blades and the resulting shaping of the milling tool can in many cases be reduced only with significant effort. In particular in the case of incision milling tools comprising a single peripheral blade and one flute extending along the cutting edge, an imbalance specified by the asymmetrical arrangement of the peripheral blades often cannot be entirely prevented. An imbalance often also occurs in the case of multi-blade milling tools, the cutting edges of which are not uniformly distributed in the peripheral direction.

It has been found that, in addition to the already known adverse effects such as increased noise generation and greater wear, the machining precision is also impaired. For example, an incision milling tool has a greater mass in a peripheral region opposite the cutting edge and the flute than in the peripheral region in which the flute is arranged. In the case of high rotational speeds, the centrifugal force, which is then no longer directed uniformly in all radial directions, causes the cutting edge to be deflected owing to the greater action of the centrifugal force on the opposite side, and therefore the radial spacing between the cutting edge and the longitudinal axis of the milling tool reduces. The cutting edge of the peripheral blade which, when produced, is at a constant radial spacing from the longitudinal axis along the longitudinal axis of the milling tool, is deflected, during a milling process at high rotational speeds, by the centrifugal force, such that a milling contour or cutting contour that is curved in the direction of the axis of rotation results due to the reduced radial spacing between the cutting edge and the axis of rotation. This contour imperfection may even be in the order of magnitude of approximately 0.1 mm or more in the case of a desired planar wall surface that is created by a milling tool comprising a peripheral blade that extends over several centimeters. The undesired deflection of the cutting edge during a milling process at high rotational speeds in addition increases with an increasing length of the milling portion and with the associated asymmetrical distribution of mass of the milling tool. In the case of milling tools comprising a long milling portion or comprising a peripheral blade that extends over a large portion along the longitudinal axis, as is advantageous for quick chip removal and machining of surfaces of workpieces, the undesired deflection of the cutting edge caused by the imbalance increases as the distance from the shank increases, and may lead to significant impairment of the maximum machining precision achievable using said milling tool.

Said undesired deflection of the cutting edge during the rotation of the milling tool is also referred to in practice as a circular path imperfection and describes the deviation of the rotating cutting edge from the circular path intended for each portion along the longitudinal axis during the rotational movement.

### SUMMARY

An object of the present invention is considered to be that of reducing the undesired effects of a deflection of the cutting edge caused during a rotational movement, in order to allow for machining of a workpiece that is as precise as possible.

This object is achieved in that the radial spacing between the cutting edge and the longitudinal axis is specified on the basis of a specified compensation rotational speed at which a radial deflection of the cutting edge of the milling tool relative to the non-rotating milling tool occurs, such that a shell surface formed by the rotating cutting edge is circular cylindrical in the case of a rotation of the milling tool at the compensation rotational speed. In contrast thereto, in the non-rotating milling tool, the cutting edge is not at a constant spacing from the longitudinal axis, along the longitudinal axis. This makes it possible to achieve a constant spacing from the longitudinal axis and a straight course in parallel with said longitudinal axis for the cutting contour formed by the rotating cutting edge, over the entire extension of the cutting edge along the longitudinal axis, in the case of a milling process in which the milling tool rotates at the compensation rotational speed. If the milling tool is used at a rotational speed that deviates slightly from the compensation rotational speed, the deviation of the cutting edge from the circular cylindrical shell surface achieved at the compensation rotational speed, which deviation is brought about by the centrifugal force during the rotation, is relatively small and often no longer relevant for machining the workpiece at the desired precision. The compensation rotational speed may be a high rotational speed, as is generally possible for a milling process using a comparable milling tool or is specified in practice. It is thereby possible, in the case of milling tools having an imbalance, to prevent the surfaces created at high rotational speeds from having an undesired curvature which increases as the spacing between the cutting edge and the shank of the milling tool increases and results in a very significant reduction in the dimensional accuracy during the milling process in particular in the case of workpiece surfaces having dimensions in the range of several centimeters or more.

In this case, the longitudinal axis denotes an axis of rotation about which the milling tool rotates in the shank when the shank of the milling tool is mounted in a tool spindle of a milling machine and is rotated by the tool spindle. At least in the shank, the longitudinal axis of the milling tool also corresponds, in many cases, to a central axis of the milling tool. In the case of a slow rotational movement, the longitudinal axis in the region of the milling portion also substantially corresponds to the axis of rotation.

Such an adjustment of the radial spacing of the cutting edge along the longitudinal axis is relevant in particular for incision milling tools which comprise a single peripheral blade that extends over the milling portion, in the direction of the longitudinal axis, at least in portions. As a result of the single peripheral blade and the flute associated with said peripheral blade, which in each case necessarily cannot be arranged so as to be symmetrical relative to the longitudinal axis, incision milling tools have a design-related imbalance. Said imbalance results in significant impairment of the milling process and an undesired reduction in the maximally achievable precision during workpiece machining, in particular in the case of large diameters of the milling tool of for example 4 mm and more, and in the case of high rotational speeds. Disruptive imbalances, which may lead to undesired deflection of the cutting edges in question, may also arise in the case of milling tools that comprise a plurality of peripheral blades which are, however, not uniform or not symmetrical relative to the longitudinal axis, or in which the respective flutes associated with one cutting edge in each case are differently shaped.

According to an advantageous embodiment of the inventive concept, the radial spacing of the cutting edge increases continuously or decreases continuously as the distance from the shank increases. The centrifugal forces acting on the milling tool during a rotational movement result in the milling tool being bent and the undesired deflection of the cutting edge increasing as the distance from the shank increases. A continuously increasing or decreasing radial spacing of the cutting edge can compensate for this undesired deflection in a suitable manner.

A continuously increasing spacing is advantageous for example in the case of incision milling tools, in which a large flute directly beside a cutting edge results in less mass being arranged in the region of the cutting edge than in an opposite peripheral region. A continuously decreasing spacing is expedient and is necessary for compensation in the case of milling tool geometries in which there is a greater accumulation of mass in the region of the cutting edge than in an opposite peripheral region of the milling tool. It is also possible for a large imbalance of the milling tool in a region that is axially spaced from the cutting edge along the longitudinal axis to bring about a rotation-related deformation of the milling tool in the region of the cutting edge, which can be corrected and compensated by means of a corresponding correction of the course or of the radial spacing of the cutting edge.

According to an advantageous embodiment of the inventive concept, a structural measure, which is easy and cost-effective to implement, for at least reducing the undesired deflection of the cutting edge during a rotational movement can be achieved in that the radial spacing of the cutting edge increases or decreases proportionally to the distance from the shank, in the direction of an end face of the milling tool, as said distance increases. Such a shaping of the milling portion of the milling tool can be specified in a simple manner and without significant effort. Nonetheless, such a course of the cutting edge allows for a reduction in the undesired deflections of the cutting edge during the rotational movement that is already advantageous or sufficient for many fields of application.

The influence of the radial spacing between the cutting edge and the longitudinal axis, and the design according to the invention of a cutting edge course which is at a different radial spacing from the longitudinal axis along the longitudinal axis, can advantageously also be used for producing a wall surface of a workpiece having specified geometric properties. The invention therefore also relates to a method for producing a wall surface of a workpiece that is convexly or concavely curved in the longitudinal direction of a milling tool, wherein the milling tool having the features described above, which tool rotates at a specified rotational speed, is displaced relative to the workpiece such that the rotating peripheral blade of the tool creates the wall surface. In this case, according to the invention, in order to produce a wall surface that is convexly curved relative to the workpiece the rotational speed of the rotating milling tool is specified so as to be lower than the compensation rotational speed of the milling tool, and in order to produce a wall surface that is concavely curved relative to the workpiece the rotational speed of the rotating milling tool is specified so as to be greater than the compensation rotational speed. According to the invention, the dependency of the deflection of the cutting edge, caused by the centrifugal force, on the relevant rotational speed of the rotating milling tool can be used and taken advantage of in order to influence the cutting contour of the cutting edge resulting during a rotation, by means of specifying a lower or higher rotational speed. If the milling tool rotates at a lower rotational speed than the compensation rotational speed, the radially outwardly projecting cutting edge is displaced less towards the longitudinal axis and thus to a smaller radial spacing than in the case of the compensation rotational speed. As a result, the cutting edge projects radially outwards as the distance between the cutting blade and the shank increases, and penetrates deeper into the workpiece to be machined as the distance from the shank decreases. The separation plane or wall surface of the workpiece that is created transversely to the longitudinal direction then has a convex curvature. An undercut created in this manner may be advantageous for various uses or products.

If the rotational speed is specified so as to be greater than the compensation rotational speed, the centrifugal forces acting on the milling portion of the milling tool during the rotary movement thus bring about greater deflection of the cutting edge than that brought about by the value specified as the next greatest radial spacing between the cutting edge and the longitudinal axis, with the result that the cutting edge is increasingly deflected towards the longitudinal axis, during the rotational movement, as the distance from the shank increases. In the case of a displacement of the rotating milling tool transversely to the longitudinal axis, a concavely curved wall surface is created when the milling tool is engaged in the workpiece. The milling tool can also create blind bores in the workpiece at rotational speeds that are greater than the compensation rotational speed, the diameter of which bores decreases as the immersion depth of the milling tool increases.

According to an optional embodiment of the inventive concept, it is also conceivable and, for various applications, advantageous, for the rotational speed of the rotating milling tool to be specified so as to be lower than the compensation rotational speed, in order to produce a wall surface of a workpiece that extends in a straight line in the longitudinal direction, and for the milling tool to be displaced in the longitudinal direction, relative to the wall surface to be machined, such that in each case just a sub-portion of the peripheral blade that adjoins an end face of the milling tool comes into engagement with the workpiece during the milling process. In this manner, it is possible to limit the wear of the milling tool, on a sub-portion of the peripheral blade that adjoins an end face of the milling tool, resulting during production of a straight wall surface. A sufficiently large number of displacement steps, by means of which the milling tool plunges deeper, stepwise, into the workpiece to be machined, makes it possible to create a substantially straight wall surface in which the slight curvature of the wall surface remaining between two immersion depths is no longer noticed or is at least not perceived as disruptive.

Various aspects of the milling tool according to the invention and the use thereof in the embodiments, shown by way of example, will be explained in greater detail in the following.

### BRIEF DESCRIPTION OF THE DRAWINGS

FIG. 1 is a schematic and perspective view of a milling tool comprising a peripheral blade.

FIG. 2 is a view of the milling tool shown in FIG. 1, at an end face of the milling tool.

FIG. 3 is a schematic view of the radial spacing of the cutting edge of a conventional milling tool (right-hand side of a dotted longitudinal axis), and of the radial spacing of a peripheral region of the milling tool opposite the cutting edge (left-hand side), wherein the milling tool does not rotate.

FIG. 4 is a schematic view of the radial spacing of the cutting edge from the longitudinal axis (right-hand side), and of the radial spacing of the opposite peripheral region (left-hand side) in the conventional milling tool during a rotational movement, wherein the respective contours of the cutting edge and of the opposite peripheral region when the milling tool is stationary are indicated in dashed lines for the purpose of clarification.

FIG. 5 shows the radial spacing of the cutting edge of a milling tool designed according to the invention (right-hand side), and the radial spacing of an opposite peripheral region (left-hand side), when the milling tool is stationary.

FIG. 6 shows the radial spacing of the cutting edge relative to the longitudinal axis (right-hand side), and the radial spacing of the opposite peripheral region (left-hand side), during a rotational movement of the milling tool according to the invention, wherein the respective contours of the cutting edge and of the opposite peripheral region when the milling tool is stationary are indicated in dashed lines for the purpose of clarification.

FIG. 7 is a schematic view of a milling tool according to the invention, in which the radial spacing of the cutting edge is specified, in the case of a compensation rotational speed that is set in advance, such that the blade that protrudes radially to an increasing extent in the case of a stationary milling tool (solid line), is at a constant radial spacing from the longitudinal axis in the case of a rotational movement at the compensation rotational speed (dashed line).

FIG. 8 is a schematic illustration of a milling process, during which the milling tool shown in FIG. 7 rotates at the compensation rotational speed and in the process creates a wall surface of a workpiece that extends in a straight line in parallel with the longitudinal axis of the milling tool.

FIG. 9 is a schematic illustration of a milling process using the milling tool shown in FIG. 7, wherein the milling tool rotates at a rotational speed that is lower than the compensation rotational speed, and as a result a wall surface that is convexly curved towards the longitudinal axis of the milling tool is created in the workpiece.

FIG. 10 is a schematic illustration of a milling process using the milling tool shown in FIG. 7 that rotates at a rotational speed that is greater than the compensation rotational speed, and as a result creates a wall surface in the workpiece that is concavely curved towards the longitudinal axis of the milling tool.

### DETAILED DESCRIPTION

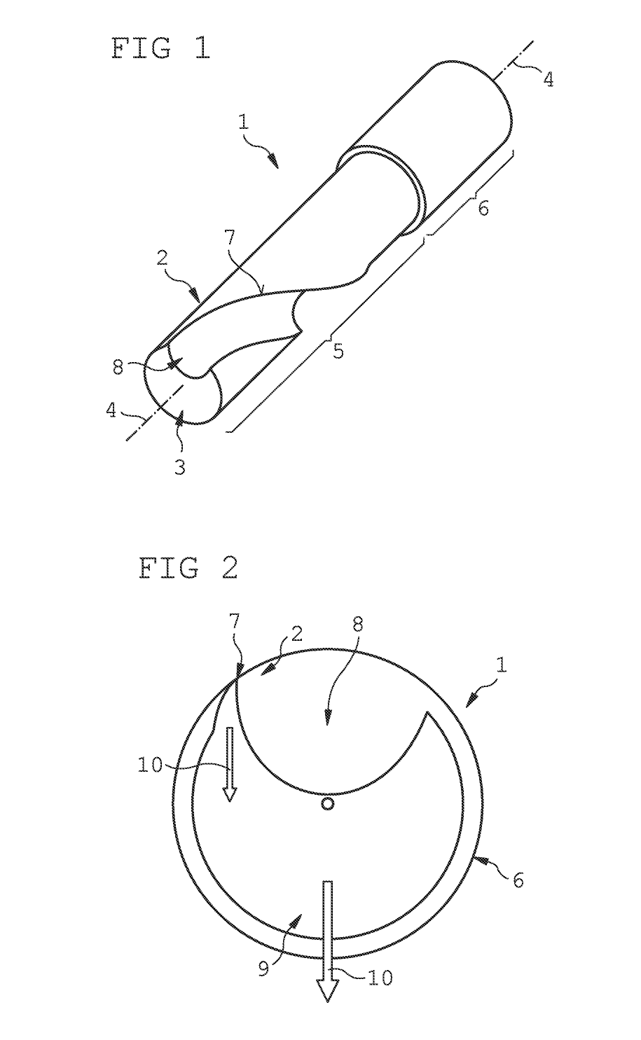

A milling tool 1 shown schematically in FIGS. 1 and 2 comprises a single peripheral blade 2 which extends, proceeding from an end face 3 of the milling tool, along a longitudinal axis 4 over a milling portion 5 to an adjoining shank 6 of the milling tool. The shank 6 of the milling tool 1 is designed such that the milling tool 1 can be received and fixed in a spindle (not shown) of a milling machine. The milling tool 1 can be rotated by the spindle and can be displaced both along the longitudinal axis 4 and transversely to the longitudinal axis 4 during a rotation about the longitudinal axis 4 at a high rotational speed.

The peripheral blade 2 comprises a cutting edge 7 that starts at the end face and extends helically to the shank 6. A flute 8 extends, so as to follow the helical course of the cutting edge 7, adjacently to the cutting edge 7, which flute is formed by a recess in the milling portion 5 that is approximately semi-circular and extends in the radial direction until close to the longitudinal axis 4. The flute 8 also extends along the longitudinal axis 4, to the shank 6. Milling tools 1 are also conceivable in which the cutting edge 7 has a course deviating herefrom, for example a course of the cutting edge 7 along the longitudinal axis 4 that is uniform in the peripheral direction and constant. The milling tool 1 could also comprise a plurality of peripheral blades 2 which are for example arranged non-symmetrically with respect to one another or extend in a non-symmetrical manner, such that an imbalance is also created in the case of two or more than two peripheral blades 2.

The flute 8 that extends beside the cutting edge 7 makes the distribution of mass, specified in the radial direction perpendicularly to the longitudinal axis 4, in the shank 6, noticeably asymmetrical, such that an imbalance is created. In the case of a rotational movement of the milling tool 1 about the longitudinal axis 4 thereof, the outwardly oriented centrifugal force acts more strongly on the relevant portion of the milling tool 1 in a peripheral region 9 opposite the flute 8, owing to the greater mass, than in the region of the flute 8, in which only a smaller centrifugal force acts owing to the mass of the milling tool 1 that is reduced by the recess of the flute 8. This leads to a resultant centrifugal force, indicated schematically by an arrow 10 in FIG. 2, which bends and deflects the milling tool 1 in said portion, as a result of which the cutting edge 7 is displaced towards the opposite peripheral region and the radial spacing between the cutting edge 7 and the longitudinal axis 4 decreases.

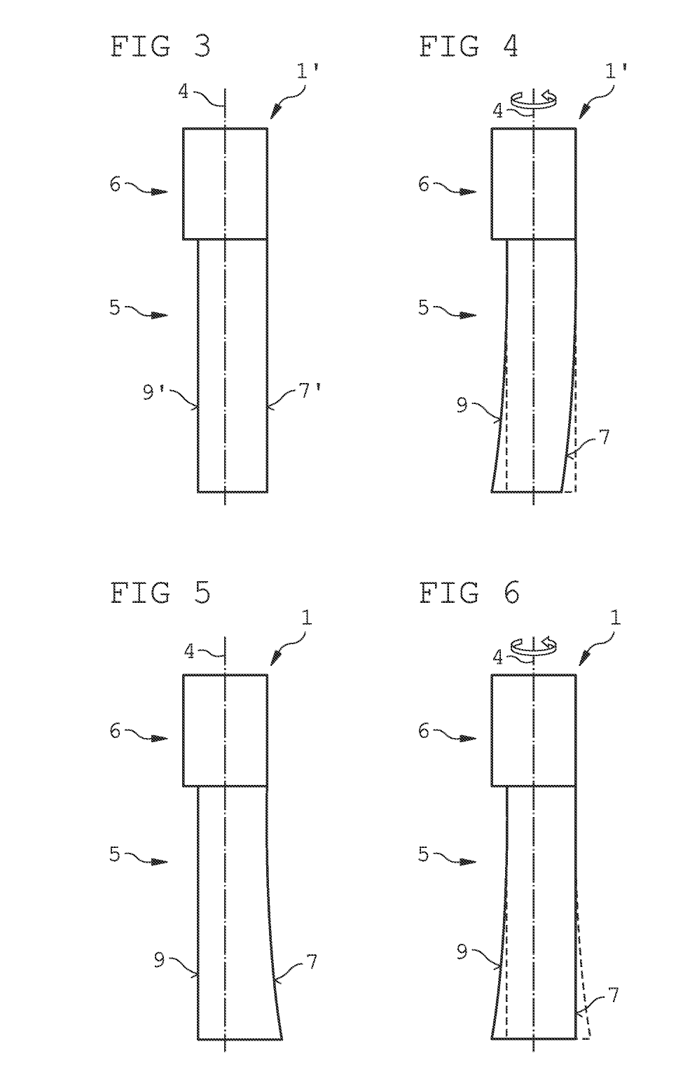

The influence of the centrifugal force on a conventional milling tool 1′ is shown schematically in FIGS. 3 and 4. In this case, just like in the following figures, a projection of the radial outer course of a cutting edge 7′ is shown along the longitudinal axis 4 in each case, on a right-hand side of the longitudinal axis 4. A projection of the radial outer course of an outer face of a peripheral region 9′ opposite the cutting edge 7′ is shown on a left-hand side of the longitudinal axis 4. The course, shown in each case, of the cutting edge 7′ along the longitudinal axis 4 corresponds, in the case of a rotating milling tool 1′, to the resulting cutting contour or milling contour. In the case of the conventional milling tool 1′ shown in FIGS. 3 and 4, during production or in a stationary milling tool 1′ a radial spacing of the cutting edge 7′ extends in parallel with the longitudinal axis 4 because the influence of the centrifugal force on the rotating milling tool 1′ is negligible. In the case of a rotational movement of the milling tool 1′ about the longitudinal axis 4, as shown in FIG. 4, a centrifugal force is generated that acts unevenly on the milling tool 1′ and that causes a deflection of the cutting edge 7′ to a smaller radial spacing from the longitudinal axis 4. This effect or the deflection of the milling tool 7′ increases as the distance from the shank 6 increases, such that a curved course of the cutting contour of the cutting edge 7′ along the longitudinal axis 4 is established and the deflection of the cutting edge 7′ is greatest in the region of the end face 3′ of the milling tool 1′.

The undesired effects of the deflection of the cutting edge 7 caused by the centrifugal force can be counteracted in that the cutting edge 7 is not at a constant radial spacing from the longitudinal axis 4 when the milling tool 1 is stationary, as is shown schematically in FIGS. 5 and 6. In this embodiment, shown by way of example, the radial spacing of the cutting edge 7 continuously increases, in a gradual manner, starting at the shank 6 and towards the end face 3 of the milling tool 1. The radial spacing of the cutting edge 7 from the longitudinal axis 4 is greatest in the region of the end face 3 of the milling tool 1. If the milling tool 1 is rotated, the centrifugal force causes a resultant deflection of the cutting edge 7 due to the distribution of mass which is non-uniform in the peripheral direction owing to the flute 8, such that the radial spacing of the cutting edge 7 from the longitudinal axis 4, initially specified as large, decreases, and a course of the cutting edge 7 that is at least approximately straight and extends in parallel with the longitudinal axis 4, and thus a straight cutting contour or milling contour, results again, during the rotational movement of the milling tool 1, i.e. during the use thereof in a milling process.

In the case of a stationary milling tool 1, the course of the cutting edge 7 or the course of the radial spacing of the cutting edge 7 can be specified such that, for a compensation rotational speed that is specified in advance, the deflection of the cutting edge 7 caused by the centrifugal force results in a straight cutting contour.

It is also possible, by means of tests and measurements carried out in advance, to determine a course of the cutting edge 7 of the milling tool 1, for a compensation rotational speed specified in advance and for a material of a workpiece specified in advance, which course compensates not only for the resulting centrifugal force but instead also other influences such as the cutting force or the chip removal, etc., during a milling process at the compensation rotational speed in the relevant material, in order to create, as a result, a cutting contour or corresponding wall surface of a workpiece that extends in a straight line in the direction of the longitudinal axis.

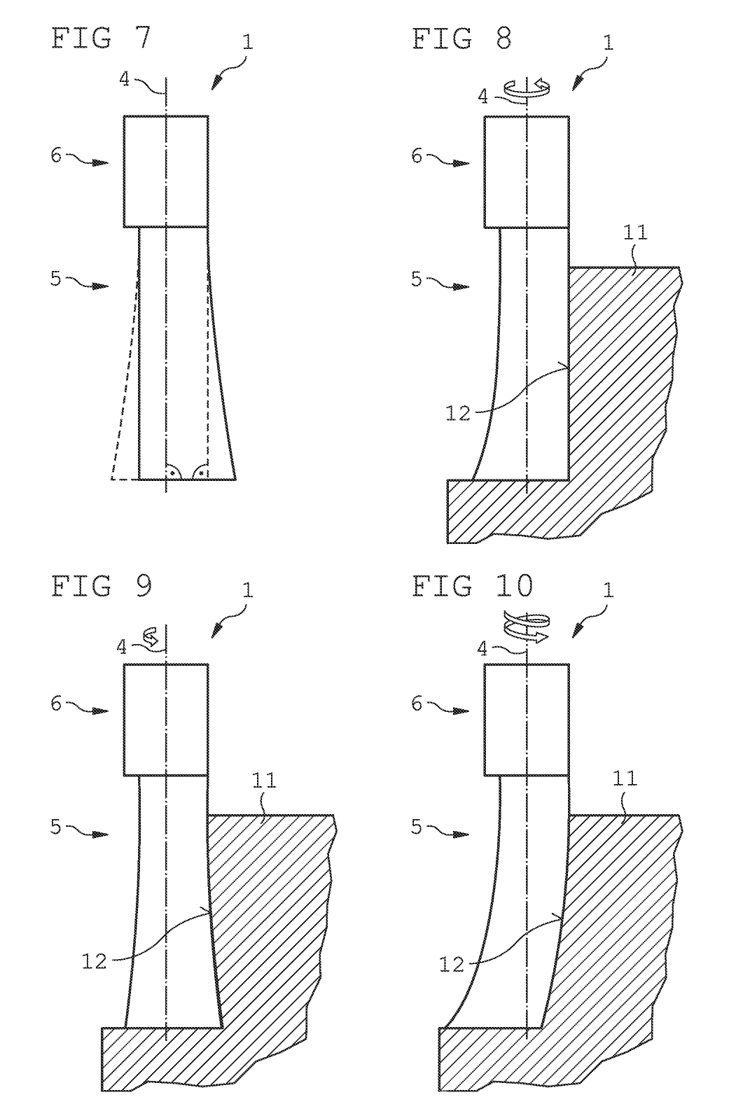

The process of influencing the course of the cutting edge 7 by means of the rotational speed of a rotational movement of the milling tool 1 can also be used, according to the invention, in order to also purposefully create a convexly or concavely curved course of the wall surface, in addition to a course of a wall surface of a workpiece that is as straight as possible. When stationary, the course (shown in a solid line) of the cutting edge 7 of a milling tool 1 according to the invention shown in FIG. 7 increases continuously as the distance from the shank 6 increases, wherein the increasing radial spacing of the cutting edge 7 from the longitudinal axis 4 has been determined and specified for a compensation rotational speed specified in advance, in such a way that the deflection of the cutting edge caused during a rotational movement at the compensation rotational speed is completely compensated and a straight cutting contour is established which is shown in dashed lines.

In the case of a milling process shown in FIG. 8, during which the milling tool 1 rotates at the compensation rotational speed, a wall surface 12 that has a straight course in the direction of the longitudinal axis 4 of the rotating milling tool 1 is created on a workpiece 11 machined by the milling process. If the milling tool 1 is moved transversely to the longitudinal axis 4, a completely planar wall surface 12 can thereby be created on the workpiece 11.

If the milling tool 1 rotates at a lower rotational speed during a milling process, as shown schematically in FIG. 9, the deflection of the cutting edge 7 caused by the centrifugal force is less than the radius increase, specified in advance, in the cutting edge course, with the result that the curved cutting contour, as is shown in FIG. 7, is not completely compensated and a wall surface 12 that is accordingly convexly curved in the direction of the longitudinal axis 4 is created on the workpiece 11. An undercut of this kind can be used advantageously for a plurality of applications.

In an analogous manner, the milling tool 1 can rotate, during a milling process, at a rotational speed that is higher than the compensation rotational speed, such that the influence of the centrifugal force is greater and the initially curved course of the cutting edge 7 is over-compensated. This results in a curved course, already known in conventional milling tools 1′, of the cutting edge 7 or of the cutting contour towards the longitudinal axis 4, or a wall surface 12 of the workpiece 11 that is correspondingly convexly curved towards the longitudinal axis 4.

The milling tool 1 according to the invention can accordingly be used to create both straight wall surfaces 12 and convexly or concavely curved wall surfaces 12 of a workpiece 11 in a purposeful and controlled manner, in accordance with the respective rotational speeds, during a milling process, without it being necessary to change the tool or for example to tilt the rotating milling tool.

1.-6. (canceled)

7. A milling tool, comprising
a shank and a milling portion which are arranged along a longitudinal axis of the milling tool,
wherein the milling portion comprises at least one peripheral blade that extends over the milling portion, in the direction of the longitudinal axis, at least in portions with a flute that adjoins a cutting edge of the peripheral blade,
wherein a radial spacing between the cutting edge and the longitudinal axis is selected on the basis of a specified compensation rotational speed at which a radial deflection of the cutting edge of the rotating milling tool occurs, such that a shell surface formed by the rotating cutting edge is circular cylindrical when the milling tool rotates at the compensation rotational speed.

8. The milling tool according to claim 7, wherein the radial spacing of the cutting edge increases or decreases continuously as a distance from the shank increases.

9. The milling tool according to claim 8, wherein the radial spacing of the cutting edge increases or decreases proportionally, in the direction of an end face of the milling tool, with the distance from the shank.

10. The milling tool according to claim 7, wherein the milling tool comprises a single peripheral blade that extends over the milling portion, in the direction of the longitudinal axis, at least in portions.

11. A method for producing a wall surface of a workpiece that is convexly or concavely curved in the direction of a longitudinal axis of a milling tool,
wherein the milling tool according to claim 8, which tool rotates at a specified rotational speed, is displaced relative to the workpiece such that the rotating peripheral blade of the milling tool creates the wall surface, and
wherein, in order to produce a wall surface that is convexly curved relative to the workpiece, the rotational speed of the rotating milling tool is selected so as to be lower than the compensation rotational speed of the milling tool, and
wherein, in order to produce a wall surface that is concavely curved relative to the workpiece, the rotational speed of the rotating milling tool is selected so as to be greater than the compensation rotational speed.

12. A method for producing a wall surface of a workpiece that extends in a straight line in the direction of a longitudinal axis of a milling tool,
wherein the milling tool according to any of claim 8, which tool rotates at a specified rotational speed, is displaced relative to the workpiece such that the rotating peripheral blade of the milling tool creates the wall surface,
wherein, in order to produce a straight wall surface the rotational speed of the rotating milling tool is selected so as to be lower than the compensation rotational speed, and
wherein the milling tool is displaced in the direction of the longitudinal axis, relative to the wall surface to be machined, such that in each case just a sub-portion of the peripheral blade that adjoins an end face of the milling tool comes into engagement with the workpiece during the milling process.
